(19) United States
(12) Patent Application Publication
(10) Pub. No.: US 2024/0176681 A1
(43) Pub. Date: May 30, 2024

(54) AUTOMOTIVE SYSTEM, METHOD OF OPERATING THE SAME, AND MEMORY DEVICE FOR THE SAME

(71) Applicant: SK hynix Inc., Icheon-si Gyeonggi-do (KR)

(72) Inventors: Tae Ha KIM, Icheon-si Gyeonggi-do (KR); Jung Ae KIM, Icheon-si Gyeonggi-do (KR)

(73) Assignee: SK hynix Inc., Icheon-si Gyeonggi-do (KR)

(21) Appl. No.: 18/320,053

(22) Filed: May 18, 2023

(30) Foreign Application Priority Data
Nov. 28, 2022 (KR) 10-2022-0161330

(51) Int. Cl. G06F 9/54; G06F 1/3296

(52) U.S. Cl. CPC G06F 9/542; G06F 1/3296

(57) ABSTRACT

An automotive system includes a memory device and a controller. The memory device is installed in an automobile. The controller controls the memory device and an electronic device in the automobile. The controller controls the memory device to process a background operation during a time limit when a background operation trigger event may be detected.

### CROSS-REFERENCES TO RELATED APPLICATION

The present application claims priority under 35 U.S.C. § 119(a) to Korean application number 10-2022-0161330, filed on Nov. 28, 2022, in the Korean Intellectual Property Office, which is incorporated herein by reference in its entirety.

### BACKGROUND

### 1. Technical Field

Various embodiments generally relate to an electronic system, and more particularly, to an automotive system, a method of operating the automotive system, and a memory device for the automotive system.

### 2. Related Art

As the automotive industry progresses, advances in advanced driver assistance systems (ADAS), in-automotive infotainment (IVI), multi-vision processing (MVP), automatic driving technology, etc., are occurring.

Thus, automotive controllers having rapid computing processing capacity may be needed. Further, high-capacity and high-performance memory devices may also be needed.

A memory device for an automobile may be operated to facilitate safety of passengers, pedestrians, peripheral automobiles, etc.

### SUMMARY

According to an example embodiment, there may be provided an automotive system. The automotive system may include a memory device and a controller. The memory device may be installed at an automobile system. The controller may control the memory device and an electronic device in the automobile. The controller may control the memory device to process a background operation during a time limit when a background operation trigger event may be detected.

According to an example embodiment, there may be provided a method of operating an automotive system. The automotive system may include a memory device and a controller. The memory device may be installed at an automobile. The controller may control the memory device and an electronic device in the automobile. In the method of operating the automotive system, the controller may detect a background operation trigger event. The controller may determine a time limit. The controller may control the memory device to process a background operation during the time limit.

According to an example embodiment, there may be provided a memory device. The memory device may be electrically connected with a controller. The controller is configured to control an electronic device in an automobile. The memory device may receive a background operation processing request and a time limit from the controller to process a background operation for the time limit.

### BRIEF DESCRIPTION OF THE DRAWINGS

The above and another aspects, features, and advantages of the subject matter of the present disclosure will be more clearly understood from the following detailed description taken in conjunction with the accompanying drawings, in which:

FIG. 1 is a view illustrating an automotive system in accordance with an example embodiment;

FIG. 2 is a view illustrating a driving control device in accordance with an example embodiment;

FIG. 3 is a view illustrating a memory management circuit in accordance with an example embodiment;

FIG. 4 is a view illustrating a power supply concept of an automotive system in accordance with an example embodiment;

FIG. 5 is a flowchart illustrating a method of operating an automotive system in accordance with an example embodiment; and

FIG. 6 is a view illustrating a memory device in accordance with an example embodiment.

### DETAILED DESCRIPTION

Various embodiments of the present teachings will be described in greater detail with reference to the accompanying drawings. The drawings are schematic illustrations of various embodiments (and intermediate structures). As such, variations from the configurations and shapes of the illustrations as a result, for example, of manufacturing techniques and/or tolerances, are to be expected. Thus, the described embodiments should not be construed as being limited to the particular configurations and shapes illustrated herein but may include deviations in configurations and shapes which do not depart from the spirit and scope of the present teachings as defined in the appended claims.

The present teachings described herein with reference to cross-sections and/or plan illustrations of idealized embodiments. However, presented embodiments of the present teachings should not be construed as limiting additional possible embodiments. Although a few embodiments of the present teachings will be shown and described, it will be appreciated by those of ordinary skill in the art that changes may be made in these embodiments without departing from the principles and spirit of the present teachings.

Hereinafter, example embodiments are explained in detail with reference to accompanying drawings.

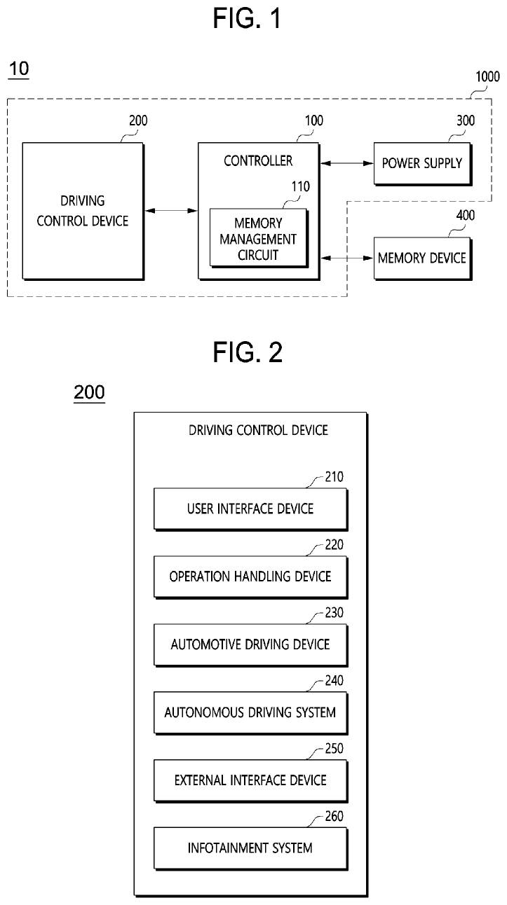

FIG. 1 is a view illustrating an automotive system in accordance with an example embodiment.

Referring to FIG. 1, an automotive system 10 of an example embodiment may be electrically connected with electronic devices such as mechanical devices and electrical devices. The automotive system 10 may include a controller 100, a driving control device 200, a power supply 300, and a memory device 400.

The controller 100 may control operations of the automotive system 10. The controller 100 may include hardware and software or firmware executed through the hardware. In an embodiment, the controller may be a controller circuit.

The controller 100 may include a memory management circuit 110 configured to control the memory device 400. Operation memory may be arranged in the controller 100. The controller 100 may correspond to an electronic control unit (ECU).

The driving control device 200 may process signals of the mechanical devices and the electric devices required for driving an automobile and using an infotainment function by handling the automobile in accordance with the controls of the controller 100.

The power supply 300 may provide power for the operation of the automotive system 10 such as the controller 100, the driving control device 200, and the memory device 400. In an example embodiment, the power supply 300 may receive power from a battery in the automobile.

The memory device 400 may include a volatile memory device and/or a non-volatile memory device. The memory device 400 may output various data such as a program, control data, input/output data, etc., for performing the driving of the automobile and auxiliary functions for the operations of the automotive system 10 in accordance with the control of the controller 100.

In an example embodiment, the controller 100, the driving control device 200, and the power supply 300 may correspond to an external device 1000. The controller 100, the driving control device 200, and the power supply 300 may be operated as a host device with respect to the memory device 400. The memory device 400 may store data accessed by the external device 1000. That is, the memory device 400 may be used as a main memory device or an auxiliary memory device of the external device 1000.

FIG. 2 is a view illustrating a driving control device in accordance with an example embodiment.

Referring to FIG. 2, the driving control device 200 may include a user interface device 210, an operation handling device 220, an automotive driving device 230, an autonomous driving system 240, an external interface device 250, and an infotainment system 260. Some or all of these devices and systems may include electronic circuits.

In an example embodiment, the driving control device 200 may further include one or more additional elements as well as the above-indicated elements in FIG. 2. Alternatively, the driving control device 200 might not include one or more of the above-indicated elements in FIG. 2.

The user interface device 210 may include an input configured to receive a control command from a user and an output configured to provide the user with states of the automobile. The input may include a key box. The user may apply power to the automobile or start the automobile through the key box.

The operation handling device 220 may receive and process a steering control signal, an acceleration control signal, a brake control signal, etc., from the user interface device 210.

The automotive driving device 230 may be configured to control various parts such as a power train, a chassis, a door, a window, a mirror, a lamp, an air conditioner, a safety equipment, etc.

The autonomous driving system 240 may control actions of the automobile in accordance with a drive mode such as driving, parking, etc., of the automobile.

The external interface device 250 may provide a communication path to external devices connected to the automobile. For example, the external interface device 250 may include a port connected to mobile terminal equipment such as a smart phone. The external interface device 250 may be connected with the mobile terminal equipment through the port to exchange data or to supply electrical energy to the mobile terminal equipment.

The infotainment system 260 may provide the user with environments where convenience services in the automobile such as a navigator, a black box, an internet, a multi-media, etc., may be used.

After power is supplied to the automobile, the controller 100 may access the memory device 400 to process signals in accordance with requests of the user.

The memory device 400 may include a non-volatile memory device. A flash memory device of the non-volatile memory device cannot do an overwrite or an in-place update. Further, the flash memory device may have a read/write unit and an erase unit different from each other. Thus, the data inputted by the overwrite request of the external device 1000 may be stored in a physical region different from a region where previous data may be stored, not be overwritten in the memory device 400. Therefore, it may be required to manage storage spaces of the flash memory device by performing a housekeeping operation such as garbage collection, data migration, wear leveling, read reclaim, etc. The housekeeping operation may be performed in the background so as not to interfere with a foreground operation for processing the request of the external device 1000.

Therefore, the controller 100 may include the memory management circuit 110. The controller 100 may manage the memory device 400 to prevent an influence of the automotive driving through the memory management circuit 110.

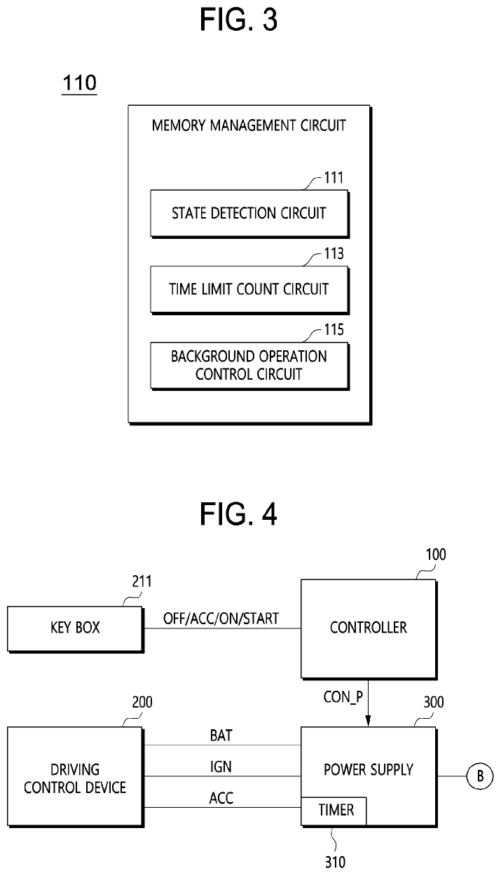

FIG. 3 is a view illustrating a memory management circuit in accordance with an example embodiment.

Referring to FIG. 3, the memory management circuit 110 may include a state detection circuit 111, a time limit count circuit 113, and a background operation control circuit 115.

The state detection circuit 111 may check whether a background operation trigger event for guaranteeing idle state of the memory device 400 has been generated or not. The state detection circuit 111 may check whether an interrupt event has been generated in the automotive system 10. For example, the interrupt event may be detected when a process requiring an access to the memory device 400 such as the starting by the user or the operation of the infotainment system 260 during the memory device 400 may process the background operation.

The background operation trigger event may be generated when the user may require a power-off of the automotive system 10 with the power being supplied to the automobile or when the access request to the memory device 400 might not be generated for a set time with the power being supplied to the automobile.

The time limit count circuit 113 may determine and count a time limit allotted to the background operation by detecting the background operation trigger event. When the background operation trigger event may be generated by the power-off, the power supply 300 may maintain the power supply to the automotive system 10 for the time limit.

The background operation control circuit 115 may transmit a background operation request signal including the time limit to the memory device 400. When the interrupt signal may be detected from the automotive system 10 in processing the background operation by the memory device 400, the background operation control circuit 115 may transmit a background operation abort request signal to the memory device 400.

Thus, when the background operation trigger event may be detected, the memory device 400 may process the background operation during the time limit determined by the external device 100 in accordance with the request of the external device 1000.

When the access request to the memory device 400 may not be generated for the set time such as the user may off the power of the automobile or the infotainment system 260, the background operation trigger event may be generated. Thus, the background operation of the memory device 400 may be performed without the influence of the foreground operation of the external device 1000.

FIG. 4 is a view illustrating a power supply concept of an automotive system in accordance with an example embodiment.

Referring to FIG. 4, the key box 211 may be a kind of the user interface device 210. The key box 211 may be a switch to supply power to the automobile or for starting the automobile. The key box 211 may include a mechanical type rotated by inserting a key or a button type.

By operating the key box 211, the automobile may be transited to off-state OFF in which the power may not be supplied to the automobile, an accessary power supply state ACC in which the power may be supplied to a part of the equipment in the automobile, on-state ON in which the power may be supplied to all the equipment in the automobile, or start state START in which a starter motor may be driven to operate a power source such as an engine, a motor, etc.

The controller 100 may detect the states OFF, ACC, ON and START of the key box 211 to transmit a power control signal CON_P to the power supply 300.

The power supply 300 may receive the power corresponding to the states of the key box 211 OFF, ACC, ON, and START in response to the power control signal CON_P.

In an example embodiment, the power supply 300 may include a power distributer configured to supply or block power supplied from the battery to the elements of the driving control device 200.

That is, the power supply 300 may provide different first to third types powers BAT, IGN, and ACC in accordance with the power of the automobile and starting states.

The first type power BAT may be power constantly supplied to the automotive system 10 from the battery B. The instruments connected to the first type power supply BAT may receive power from the battery B except that the battery B may be discharged.

The second type power IGN may be power supplied from the battery B when the automobile may be the on-state ON or the start state START.

The third type power ACC may be power supplied from the battery B or a charger for charging the battery B in the accessary power supply state ACC. For example, the third type power ACC may be supplied to the door, a window open/close apparatus, etc. When the power of the automobile may be transited to the off-state OFF though the key box 211, the power supply 300 may additionally supply the third type power ACC to the door or the window for a time set in a timer 310 to control the door or the window by the user after the power-off.

Therefore, when the user may power-off the automobile to detect the background operation trigger event, the memory device 400 may perform the background operation during the third type power ACC may be maintained.

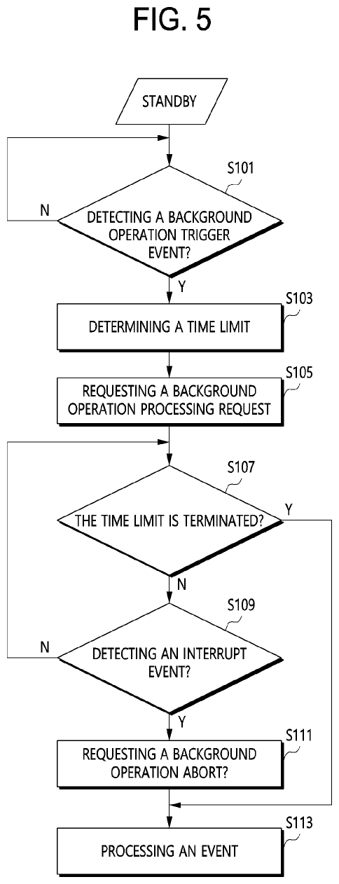

FIG. 5 is a flow chart illustrating a method of operating an automotive system in accordance with an example embodiment.

Referring to FIG. 5, in step S101, the external device 1000, particularly, the memory management circuit 110 of the controller 110, may check whether a background operation trigger event has been generated or not. When a background operation trigger event has not been detected, the detection of the background operation trigger event may be continued.

In an example embodiment, a background operation trigger event may guarantee the maintenance of the memory device 400 in the idle state for the set time. A background operation trigger event may be generated when the user may request the power-off of the automotive system 10 with the power being supplied to the automobile or the access request to the memory device 400 may not be generated for the set time with the power being supplied to the automobile.

In contrast, when a background operation trigger event has been detected, in step S103, the external device 1000 may determine and count the time limit for performing the background operation. When the background operation trigger event may be generated by the power-off, the power supply 300 of the external device 1000 may maintain supplying power to the automotive system for the time limit.

In step S105, the external device 1000 may transmit the background operation request signal including the time limit to the memory device 400. Thus, the memory device 400 may perform the background operation including the housekeeping operation such as the garbage collection, the data migration, the wear leveling, the read reclaim, etc.

In step S107, the external device 1000 may check whether the time limit has expired or terminated. When the time limit has not terminated, in step S109, whether the interrupt event may be generated in the external device 1000 or not may be checked. For example, the interrupt event may be detected when the process requiring the access to the memory device 400 such as the starting of the automobile by the user or the operation of the infotainment in processing the background operation by the memory device 400 may be performed.

When an interrupt event is detected, in step S111, the external device 1000 may transmit the background operation abort request signal to the memory device 400.

In contrast, when an interrupt event is not detected, the external device 1000 may check whether the time limit has terminated. When the time limit has terminated, in step S113, the external device 1000 may process the power-off event detected in step S101 or the interrupt event detected in step S109.

Therefore, when the memory device 400 may be in the idle state with respect to the foreground operation, i.e., the user may power-off the automotive system 10 or the infotainment system 260 may not be activated, the memory device 400 may be managed in optimal state with guaranteeing of the operational performance of the external device 1000.

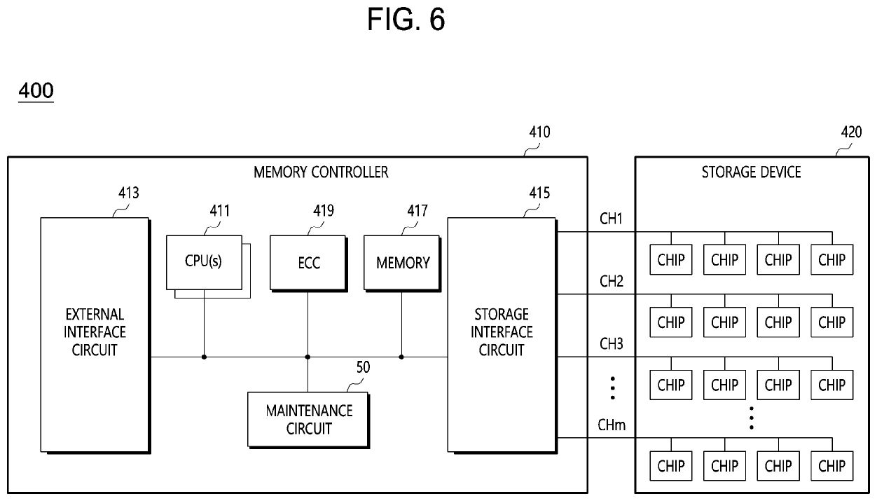

FIG. 6 is a view illustrating a memory device in accordance with an example embodiment.

Referring to FIG. 6, the memory device 400 may include a memory controller 410 and a storage device 420. The memory device 400 may be connected to an external device to exchange data with the external device.

The external device may include a personal computer, a laptop computer, a server computer, a workstation, a tablet PC, a drone, an ADAS, a smart TV, a smart phone, a medical device, an image display, a calibrator, an IOT, etc. For example, the external device may include the external device 100 in FIG. 1.

The storage device 420 may include at least one of a volatile memory device and a non-volatile memory device. The storage device 420 may be electrically connected with the memory controller 410 through a plurality of channels CH1, CH2, CH3, . . . , CHm. The storage device 420 may include a plurality of memory chips CHIP or a plurality of packages.

The memory controller 410 may control the storage device 420 in response to a request of the external device. For example, the memory controller 410 may control the storage device 420 to program data in the storage device 420 in accordance with a write request of the external device. The memory controller 410 may provide the data in the storage device to the external device in response to a read request of the external device.

The memory controller 410 may include at least one processor 411, an external interface circuit 413, a storage interface circuit 415, a memory 417, an error correction circuit (ECC) 419, and a maintenance management circuit 50.

The processor 411 may include a hardware and a software or a firmware operated by the hardware for the memory device 400. In an example embodiment, the processor 411 may perform a function of a flash translation layer (FTL) such as the garbage collection, the address mapping, the wear leveling, etc., for managing the storage device 420.

The external interface circuit 413 may provide a communication channel for receiving a command and a clock signal from the external device in accordance with the control of the processor 411 and for controlling the data input/output. Particularly, the external interface circuit 413 may provide a physical connection between the external device and the memory device 400.

In an example embodiment, the external interface circuit 413 may include USB (Universal Serial Bus) protocol, MMC (multimedia card) protocol, PCI (peripheral component interconnection) protocol, PCI-E (PCI-express) protocol, ATA (Advanced Technology Attachment) protocol, SATA (Serial-ATA) protocol, PATA (Parallel-ATA) protocol, SCSI (small computer small interface) protocol, ESDI (enhanced small disk interface) protocol, IDE (Integrated Drive Electronics) protocol, private protocol, SMBus (System Management Bus) protocol, I2C (Inter-Integrated Circuit) protocol, I3C (Improved Inter-Integrated Circuit) protocol, etc.

The storage interface circuit 415 may provide a communication channel between the memory controller 400 and the storage device 420. The storage interface circuit 415 may register the data temporarily stored in a buffer memory in the storage device 420 in accordance with the control of the processor 411. The storage interface circuit 415 may transmit the data read from the storage device 420 to the buffer memory. The buffer memory may temporarily store the data. The buffer memory may be arranged inside and/or outside the memory controller 410.

The memory 417 may store data required for the operation of the memory controller 410 or the data generated by the memory controller 410.

The ECC 419 may encode the data provided from the external device or the processor 411 to store the data in the storage device 420. The ECC 419 may decode the data read from the storage device 420. The ECC 419 may correct an error in the data. The ECC 419 may then transmit the corrected data to the external device or the processor 411.

The maintenance management circuit 50 may perform a maintenance management operation of the data in the storage device 420. In an example embodiment, the maintenance management circuit 50 may perform the operation when the external device 1000 may transmit the background operation request signal including the time limit.

According to an example embodiment, the housekeeping operation of the memory device for the automobile may be performed without the influence of the operational capacity of the automotive system so that the performance of the automotive system and the memory device may be optimized.

The above-described embodiments of the present teachings are intended to illustrate and not to limit the present teachings. Various alternatives and equivalents are possible. The present teachings not limited by the embodiments described herein. Nor are the present teachings limited to any specific type of semiconductor device. Other additions, subtractions, and/or modifications are possible in view of the present disclosure and are intended to fall within the scope of the appended claims.

What is claimed is:

1. An automotive system comprising:
a memory device in an automobile; and
a controller controlling the memory device and an electronic device in the automotive system, the controller configured to control the memory device to process a background operation for a time limit when a background operation trigger event is detected.

2. The automotive system of claim 1, wherein:
the electronic device comprises a user interface circuit; and
the background operation trigger event comprises an event including a power-off requested by a user through the user interface circuit while power is supplied to the automobile.

3. The automotive system of claim 2, further comprising a power supply configured to supply power to the memory device, the electronic device, and the controller,
wherein the controller controls the power supply to supply the power to the memory device during the time limit.

4. The automotive system of claim 1, wherein the background operation trigger event comprises an event that is not generated when an access request to the memory device is not generated for a set time with power being supplied to the automobile.

5. The automotive system of claim 1, wherein the controller controls the memory device to stop the background operation when an interrupt event is generated during the time limit.

6. A method of operating an automotive system, the automotive system including a controller configured to control a memory device and an electronic device in an automobile, the method comprising:
detecting a background operation trigger event by the controller;
determining a time limit by the controller; and
controlling the memory device to process a background operation during the time limit by the controller.

7. The method of claim 6, wherein:
the electronic device comprises a user interface circuit; and
detecting the background operation trigger event comprises detecting an event including a power-off requested by a user through the user interface circuit while power is supplied to the automobile.

8. The method of claim 7, wherein:
the automotive system further comprises a power supply configured to supply power to the memory device, the electronic device, and the controller; and
the controller controls the power supply to supply the power to the memory device during the time limit.

9. The method of claim 6, wherein detecting the background operation trigger event comprises detecting an event that is not generated when an access request to the memory device is not generated for a set time with power being supplied to the automobile.

10. The method of claim 6, further comprising controlling the memory device to stop the background operation by the controller when an interrupt event is generated during the time limit.

11. A memory device electrically connected to a controller, the controller configured to control an electronic device in an automobile,
wherein the memory device receives a background operation processing request and a time limit from the controller to process a background operation during the time limit.

12. The memory device of claim 11, wherein the background operation is stopped when a background operation abort request is received from the controller during the time limit.
